(19) United States
(12) Patent Application Publication
(10) Pub. No.: US 2025/0300302 A1
(43) Pub. Date: Sep. 25, 2025

(54) ELECTRICITY STORAGE CELL

(71) Applicant: TOYOTA JIDOSHA KABUSHIKI KAISHA, Toyota-shi (JP)

(72) Inventors: Masato ONO, Nagoya-shi (JP); Masahiro Ishizuka, Toyota-shi (JP); Atsushi Sugihara, Toyota-shi (JP); Yuka Yokol, Nagoya-shi (JP); Ryosuke Sato, Toyota-shi (JP); Keitaro Machida, Hamamatsu-shi (JP); Tatsuya Yamamoto, Toyohashi-shi (JP)

(73) Assignee: TOYOTA JIDOSHA KABUSHIKI KAISHA, Toyota-shi (JP)

(21) Appl. No.: 19/034,977

(22) Filed: Jan. 23, 2025

(30) Foreign Application Priority Data
Mar. 22, 2024 (JP) 2024-046303

(51) Int. Cl. H01M 50/271; H01M 50/211; H01M 50/264

(52) U.S. Cl. CPC H01M 50/271; H01M 50/211; H01M 50/264

(57) ABSTRACT

An electricity storage cell includes at least one cell unit, and a cell case that accommodates the at least one cell unit. The cell case includes a case main body having an opening on an upper side, and a lid connected to the case main body so as to close the opening of the case main body. The case main body includes a bottom wall positioned below the at least one cell unit. The lid includes a pressing portion that presses the at least one cell unit toward the bottom wall.

### CROSS-REFERENCE TO RELATED APPLICATION

This application claims priority to Japanese Patent Application No. 2024-046303 filed on Mar. 22, 2024, incorporated herein by reference in its entirety.

### BACKGROUND

### 1. Technical Field

The present disclosure relates to an electricity storage cell.

### 2. Description of Related Art

For example, Japanese Unexamined Patent Application Publication (Translation of PCT Application) No. 2023-509216 (JP 2023-509216 A) discloses a battery including a plurality of electrode assembly sets and a case that accommodates the electrode assembly sets. The electrode assembly sets are connected in series to each other by a first connecting member.

### SUMMARY

In the battery described in JP 2023-509216 A, the electrode assembly set may be displaced relative to the case due to vibrations or the like.

The present disclosure has an object to provide an electricity storage cell capable of reducing displacement of a cell unit relative to a cell case.

An electricity storage cell according to one aspect of the present disclosure includes at least one cell unit, and a cell case that accommodates the at least one cell unit. The cell case includes a case main body having an opening on an upper side, and a lid connected to the case main body so as to close the opening of the case main body. The case main body includes a bottom wall positioned below the at least one cell unit. The lid includes a pressing portion that presses the at least one cell unit toward the bottom wall. The pressing portion has a shape that is recessed toward the at least one cell unit.

According to the present disclosure, it is possible to provide the electricity storage cell capable of reducing the displacement of the cell unit relative to the cell case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an electricity storage cell in one embodiment of the present disclosure;

FIG. 2 is a front view of the electricity storage cell;

FIG. 3 is a sectional view taken along the line III-III of FIG. 2;

FIG. 4 is a sectional view schematically illustrating an electrode assembly;

FIG. 5 is a sectional view schematically illustrating a modification example of a lid; and

FIG. 6 is a sectional view schematically illustrating a modification example of the lid.

### DETAILED DESCRIPTION OF EMBODIMENTS

An embodiment of the present disclosure is described with reference to the drawings. It is to be noted that, in the drawings to be referred to below, like or corresponding members are denoted by like reference symbols.

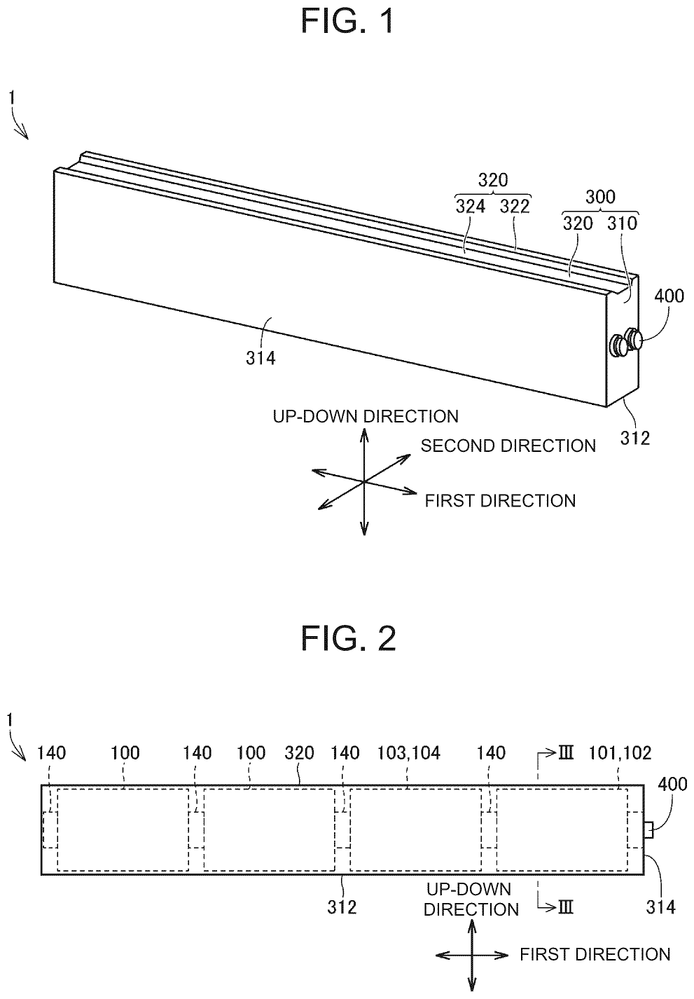

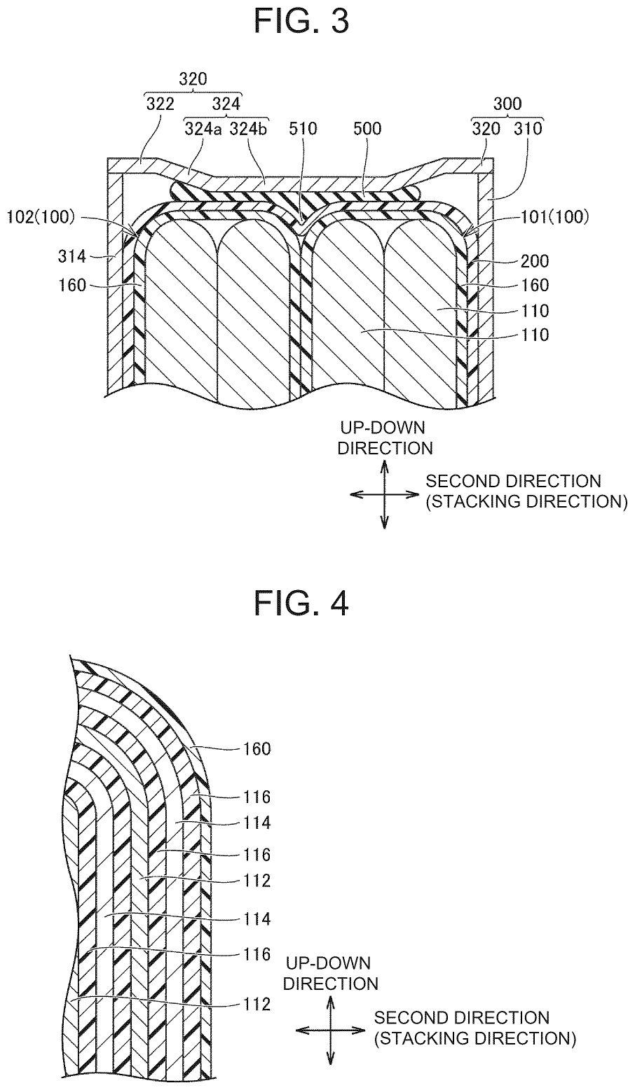

FIG. 1 is a perspective view schematically illustrating an electricity storage cell in one embodiment of the present disclosure. FIG. 2 is a front view of the electricity storage cell. FIG. 3 is a sectional view taken along the line III-III of FIG. 2. FIG. 4 is a sectional view schematically illustrating an electrode assembly. An electricity storage cell 1 is mounted on, for example, a bottom portion of a vehicle.

As illustrated in FIG. 1 to FIG. 4, the electricity storage cell 1 includes a plurality of cell units 100, a covering sheet 200, a cell case 300, external terminals 400, and an adhesive member 500.

As illustrated in FIG. 2, the cell units 100 include a first cell unit 101, a second cell unit 102, a third cell unit 103, and a fourth cell unit 104. In this embodiment, the cell units 100 include eight cell units 100. However, the number of the cell units 100 is not limited to eight. Examples of each cell unit 100 include a lithium ion battery. Each cell unit 100 may be configured of what is called an all-solid-state battery including a solid electrolyte.

The first cell unit 101 is connected to the third cell unit 103. The second cell unit 102 is connected to the fourth cell unit 104. The first cell unit 101 and the second cell unit 102 are adjacent to each other in a second direction (a direction orthogonal to the drawing sheet of FIG. 2) orthogonal to both of an up-down direction and a first direction in which the first cell unit 101 and the third cell unit 103 are arranged. The third cell unit 103 and the fourth cell unit 104 are adjacent to each other in the second direction. Each cell unit 100 has a shape that extends longer in the first direction than in the second direction and extends longer in the first direction than in the up-down direction. Each cell unit 100 has a shape that extends longer in the up-down direction than in the second direction.

As illustrated in FIG. 2 to FIG. 4, each cell unit 100 includes at least one electrode assembly 110, a current collector terminal 140, and a laminate outer casing 160.

As illustrated in FIG. 3, the at least one electrode assembly 110 includes two electrode assemblies 110. However, the number of the electrode assemblies 110 is not limited to two. As illustrated in FIG. 4, each electrode assembly 110 is configured of a wound assembly obtained by winding a positive electrode sheet 112 and a negative electrode sheet 114 through intermediation of a separator 116. However, each electrode assembly 110 may be configured of a stack obtained by stacking the positive electrode sheet 112 and the negative electrode sheet 114 through intermediation of the separator 116. The two electrode assemblies 110 are adjacent to each other in a stacking direction in which the positive electrode sheet 112 and the negative electrode sheet 114 are stacked on each other. Each electrode assembly 110 is formed in a shape that is long in an orthogonal direction (an axial direction of the wound assembly) orthogonal to both of the stacking direction and the up-down direction. The stacking direction (a thickness direction) corresponds to the second direction, and the orthogonal direction (the axial direction of the wound assembly) corresponds to the first direction.

The current collector terminal 140 is connected to the electrode assembly 110. The current collector terminal 140 protrudes from the electrode assembly 110 in the first direction. The current collector terminal 140 electrically connected to the positive electrode sheet 112 in the electrode assembly 110 is made of, for example, aluminum. The current collector terminal 140 electrically connected to the negative electrode sheet 114 in the electrode assembly 110 is made of, for example, copper. The current collector terminal 140 is formed in a flat plate shape.

The laminate outer casing 160 accommodates the electrode assembly 110. The laminate outer casing 160 is made of a laminated film. The current collector terminal 140 protrudes from an edge portion of the laminate outer casing 160 in the first direction.

The covering sheet 200 covers the cell units 100. More specifically, the covering sheet 200 covers the cell units 100 so as to collectively surround the cell units 100. The covering sheet 200 is made of an insulating material (such as synthetic resin). It is to be noted that the covering sheet 200 may be omitted.

The cell case 300 accommodates the cell units 100. The cell case 300 is made of, for example, aluminum. The cell case 300 is formed in a cuboid shape. Each cell unit 100 is accommodated in the cell case 300 in such a posture that the center axis of the electrode assembly 110 is in parallel with the first direction. As illustrated in FIG. 1 to FIG. 3, the cell case 300 includes a case main body 310 and a lid 320.

The case main body 310 has a shape with an opening on an upper side. The case main body 310 includes a bottom wall 312 and a peripheral wall 314.

The bottom wall 312 is positioned below the cell units 100. The bottom wall 312 supports the cell units 100. The bottom wall 312 may be formed in a flat plate shape.

The peripheral wall 314 rises from an outer edge portion of the bottom wall 312. The peripheral wall 314 surrounds the cell units 100. The peripheral wall 314 is formed in a rectangular tube shape. A pair of external terminals 400 is provided at a side portion of the peripheral wall 314 in the first direction.

The lid 320 is connected to the case main body 310 by welding or the like so as to close the opening of the case main body 310. The lid 320 includes a pair of base portions 322 and a pressing portion 324.

The base portions 322 are separated from each other in the second direction. Each base portion 322 is connected to an upper end portion of the peripheral wall 314. Each base portion 322 is formed flat. Each base portion 322 extends along the first direction.

The pressing portion 324 is provided between the base portions 322. The pressing portion 324 couples the base portions 322 to each other. The pressing portion 324 presses the cell unit 100 toward the bottom wall 312. The pressing portion 324 presses both of a pair of cell units adjacent in the second direction (for example, the first cell unit 101 and the second cell unit 102) toward the bottom wall 312. The pressing portion 324 has a shape that is recessed toward the cell unit 100 from the base portions 322. The pressing portion 324 extends along the first direction. As illustrated in FIG. 1 and FIG. 3, the pressing portion 324 includes a pair of inclined portions 324a and a pressure portion 324b.

Each inclined portion 324a is connected to an end portion of the base portion 322 on the inner side in the second direction. Each inclined portion 324a is gradually inclined from the end portion of the base portion 322 on the inner side in the second direction toward the inner side in the second direction so as to be directed toward the cell unit 100.

The pressure portion 324b couples the inclined portions 324a to each other. The pressure portion 324b straddles the cell units 100 adjacent in the second direction. The pressure portion 324b presses both of the cell units 100 adjacent in the second direction downward. The pressure portion 324b is formed in a flat plate shape.

The pressing portion 324 may be formed on the lid 320 by pressing or the like before the lid 320 is connected to the case main body 310, or may be formed on the lid 320 after the lid 320 is connected to the case main body 310.

It is to be noted that the bottom wall 312 of the case main body 310 may also be formed to have the same structure as the structure of the lid 320.

The adhesive member 500 fixes each cell unit 100 to the cell case 300. In this embodiment, the adhesive member 500 fixes each cell unit 100 to the cell case 300 through intermediation of the covering sheet 200. The adhesive member 500 may be made of a thermally conductive adhesive. As illustrated in FIG. 3, the adhesive member 500 is provided between the pressure portion 324b and both of the cell units 100 adjacent in the second direction. The adhesive member 500 includes an intermediate adhesive portion 510 entering a space between the cell units 100 adjacent in the second direction. It is to be noted that the adhesive member 500 may be provided between the bottom wall 312 and both of the cell units 100 adjacent in the second direction.

As described above, in the electricity storage cell 1 according to this embodiment, the pressing portion 324 presses the cell unit 100 toward the bottom wall 312, and hence the displacement of the cell unit 100 relative to the cell case 300 is reduced.

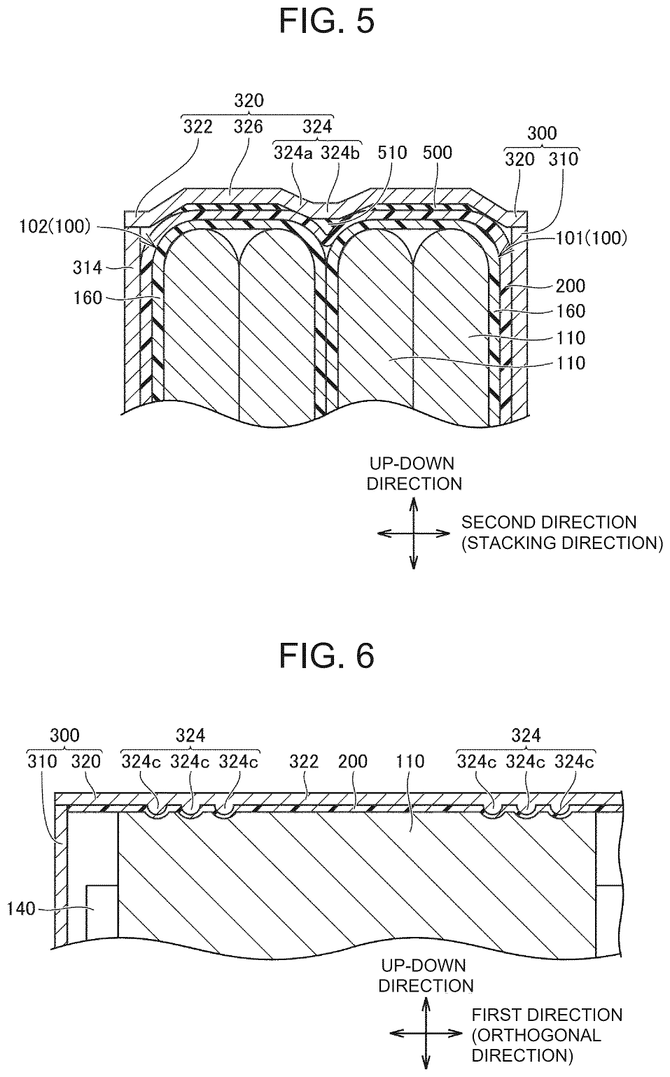

It is to be noted that, as illustrated in FIG. 5, the lid 320 may include an intermediate portion 326 formed between the base portion 322 and the pressing portion 324. The intermediate portion 326 protrudes upward from the base portion 322 and the pressure portion 324b. In other words, the intermediate portion 326 protrudes in a direction separating from the cell unit 100.

Further, as illustrated in FIG. 6, the base portion 322 may be formed in a flat plate shape that closes the opening of the case main body 310, and the pressing portion 324 may include a plurality of protrusion portions 324c provided at positions separated from each other in the orthogonal direction. The protrusion portions 324c are arranged along the orthogonal direction above each electrode assembly 110. Each protrusion portion 324c has a shape that protrudes from the base portions 322 toward the electrode assembly 110. Each protrusion portion 324c may be formed by pressing the base portion 322.

The above-mentioned exemplary embodiment is understood as a specific example of the following aspects by a person skilled in the art.

### Aspect 1

An electricity storage cell including:
at least one cell unit; and
a cell case that accommodates the at least one cell unit, in which:
the cell case includes:
a case main body having an opening on an upper side; and
a lid connected to the case main body so as to close the opening of the case main body;
the case main body includes a bottom wall positioned below the at least one cell unit;
the lid includes a pressing portion that presses the at least one cell unit toward the bottom wall; and
the pressing portion has a shape that is recessed toward the at least one cell unit.

In the electricity storage cell, the pressing portion presses the cell unit toward the bottom wall, and hence the displacement of the cell unit relative to the cell case is reduced.

### Aspect 2

The electricity storage cell according to aspect 1, in which:
the at least one cell unit includes:
   a first cell unit; and
   a second cell unit disposed adjacent to the first cell unit;
each of the first cell unit and the second cell unit includes:
   at least one electrode assembly; and
   a laminate outer casing that covers the at least one electrode assembly;
the first cell unit and the second cell unit are adjacent to each other in a stacking direction of the electrode assembly; and
the pressing portion presses both of the first cell unit and the second cell unit toward the bottom wall.

In this aspect, displacement of both of the first cell unit and the second cell unit relative to the cell case is reduced.

### Aspect 3

The electricity storage cell according to aspect 2, further including an adhesive member that fixes the first cell unit and the second cell unit to the cell case, in which:
the electrode assembly is configured of a wound assembly;
the first cell unit and the second cell unit are each accommodated in the cell case in such a posture that a center axis of the electrode assembly is orthogonal to a direction that connects the bottom wall and the lid; and
the adhesive member is provided between the pressing portion and both of the first cell unit and the second cell unit.

In this aspect, the displacement of each cell unit relative to the cell case is more reliably reduced.

### Aspect 4

The electricity storage cell according to aspect 3, in which the adhesive member includes an intermediate adhesive portion entering a space between the first cell unit and the second cell unit.

In this aspect, while the volumetric efficiency of the electricity storage cell is maintained, the displacement of each cell unit relative to the cell case can be reduced.

Note that, it is to be considered that the embodiment disclosed herein is illustrative and not restrictive in all respects. The scope of the present disclosure is defined by not the description of the above embodiment but the appended claims. The scope of the present disclosure is intended to encompass all modifications within the scope of the appended claims and equivalents thereof.

What is claimed is:

1. An electricity storage cell comprising:
at least one cell unit; and
a cell case that accommodates the at least one cell unit, wherein:
the cell case includes:
a case main body having an opening on an upper side; and
a lid connected to the case main body so as to close the opening of the case main body;
the case main body includes a bottom wall positioned below the at least one cell unit;
the lid includes a pressing portion that presses the at least one cell unit toward the bottom wall; and
the pressing portion has a shape that is recessed toward the at least one cell unit.

2. The electricity storage cell according to claim 1, wherein:
the at least one cell unit includes:
a first cell unit; and
a second cell unit disposed adjacent to the first cell unit;
each of the first cell unit and the second cell unit includes:
at least one electrode assembly; and
a laminate outer casing that covers the at least one electrode assembly;
the first cell unit and the second cell unit are adjacent to each other in a stacking direction of the electrode assembly; and
the pressing portion presses both of the first cell unit and the second cell unit toward the bottom wall.

3. The electricity storage cell according to claim 2, further comprising an adhesive member that fixes the first cell unit and the second cell unit to the cell case, wherein:
the electrode assembly is configured of a wound assembly;
the first cell unit and the second cell unit are each accommodated in the cell case in such a posture that a center axis of the electrode assembly is orthogonal to a direction that connects the bottom wall and the lid; and
the adhesive member is provided between the pressing portion and both of the first cell unit and the second cell unit.

4. The electricity storage cell according to claim 3, wherein the adhesive member includes an intermediate adhesive portion entering a space between the first cell unit and the second cell unit.
